(19) United States
(12) Patent Application Publication
(10) Pub. No.: US 2022/0084700 A1
(43) Pub. Date: Mar. 17, 2022

(54) CONTROL METHOD FOR VOLUME FRACTION OF MULTISTRUCTURAL ISOTROPIC FUEL PARTICLES IN FULLY CERAMIC MICROENCAPSULATED NUCLEAR FUELS, COMPOSITIONS FOR COATING AND SINTERED BODY OF THE SAME

(71) Applicants: University of seoul Industry Cooperation Foundation., Seoul (KR); KEPCO NUCLEAR FUEL CO.,LTD, Daejeon (KR)

(72) Inventors: Young Wook KIM, Seoul (KR); Eun Seo KANG, Seoul (KR); Seung Jae LEE, Daejeon (KR); Kwang Young LIM, Seoul (KR)

(21) Appl. No.: 17/082,001

(22) Filed: Oct. 27, 2020

(30) Foreign Application Priority Data
Sep. 14, 2020 (KR) 10-2020-0117955

(51) Int. Cl. G21C 3/62; C04B 35/565; G21C 3/20

(52) U.S. Cl. CPC G21C 3/626; C04B 35/565; G21C 3/20; C04B 2235/668; G21C 3/623; C04B 2235/604; C04B 2235/3826; C04B 2235/5445; C04B 2235/658

(57) ABSTRACT

Provided herein is a control method for volume fraction of multistructural isotropic fuel particles in a fully ceramic microencapsulated nuclear fuel including: preparing a mixture of silicon carbide, sintering additives, and organic binders, producing a coating body by coating multistructural isotropic fuel particles by using the prepared mixture, forming the coating body, and performing pressureless sintering on the formed coating body, wherein volume fraction of multistructural isotropic nuclear fuel particles may be controlled by controlling the coating layer thickness on multistructural isotropic nuclear fuel particles, wherein the coating layer was configured with a mixture of silicon carbide, sintering additives, and organic binders. As described above, stability and tolerance against nuclear fuel related accidents may be significantly enhanced, and advantageous effects of enabling a pressureless sintering procedure to be performed while maximizing volume fraction of the multistructural isotropic fuel particles may be expected.

### TECHNICAL FIELD

The present disclosure relates to a control method for volume fraction of multistructural isotropic fuel particles in fully ceramic microencapsulated nuclear fuels, compositions for coating and sintered body of the same.

And, most particularly, the present disclosure provides a control method for volume fraction of multistructural isotropic fuel particles in fully ceramic microencapsulated nuclear fuels including a step of preparing a mixture of silicon carbide, sintering additives, and organic binders, a step of producing a coating body by coating multistructural isotropic fuel particles by using the prepared mixture, a step of forming the coating body, and a step of performing pressureless sintering on the formed coating body, wherein volume fraction of multistructural isotropic nuclear fuel particles may be controlled by controlling the coating layer thickness on multistructural isotropic nuclear fuel particles, wherein the coating layer was configured with a mixture of silicon carbide, sintering additives, and organic binders.

### BACKGROUND ART

Most of the nuclear fuels being currently used are used by storing a uranium dioxide (UO₂) pellet, which is produced by a pressureless sintering method using a hydrogen atmosphere at a temperature range of 1700˜1820° C., inside a cladding (or cladding tube), which is configured of a Zirconium alloy. However, since the Fukushima nuclear power plant accident in March, 2011, requests for Accident Tolerant Fuels (ATFs) have increased, and, in order to increase the essential resistance to any possible accident, the Korean Patent Registration No. 10-1677175 and No. 10-1793896 have proposed fully ceramic microencapsulated nuclear fuels including multiple tri-structural isotropic particles embedded in a Silicon Carbide matrix. The tri-structural isotropic particles are nuclear fuels configured of a nuclear fuel kernel, a porous carbon buffer layer, an inner pyrolytic carbon layer, a chemically vapor-deposited (CVD) SiC layer, an outer pyrolytic carbon layer.

Fully ceramic microencapsulated nuclear fuels have significant advantages, such as providing nuclear fission product release restriction, environmental stability, radiation damage resistance, and proliferation resistance, as compared to the UO₂ fuel that is currently in commercial usage. The safety of tri-structural isotropic nuclear fuel particles has been proven by a radiation irradiation test performed at 1800° C. (P. A. Demkowicz, J. D. Hunn, S. A. Ploger, R. N. Morris, C. A. Baldwin, J. M. Harp, P. L. Winston, T. J. Gerczak, I. J. van Rooyen, F. C. Montgomery, C. M. Silva, Irradiation performance of AGR-1 high temperature reactor fuel, Nucl. Eng. Des. 306 (2016) 2-13. http://dx.doi.org/10.1016/j.nucengdes.2015.09.011), and fully ceramic microencapsulated nuclear fuels may be used as Accident Tolerant Fuels (ATFs) not only for the conventional light-water reactors (LWRs) but also for future-type nuclear reactors and small-sized urban nuclear reactors, which prioritize safety in nuclear development, high temperature gas-cooled reactors (HTGRs), nuclear reactors for nuclear-powered submarines and nuclear aircraft carriers, and so on.

The Korean Patent Registration No. 10-1793896 discloses a description related to a nuclear fuel including multiple tri-structural isotropic nuclear fuel particles embedded in a Silicon Carbide matrix. This document proposes, as a method for producing a Silicon Carbide matrix, a method of mixing multiple tri-structural isotropic nuclear fuel particles into Silicon Carbide powder, including Alumina (Al₂O₃) and at least one of rare earth oxides as sintering additives, and, then, performing hot pressing under a pressure of approximately 10 MPa at a temperature of approximately 1850° C. This method has a procedural inconvenience of having to prepare a separate Silicon Carbide matrix.

The Korean Patent Registration No. 10-1677175 discloses a description related to a ceramic microencapsulated nuclear fuel being configured of tri-structural isotropic nuclear fuel particles, a ceramic coating layer, and a silicon carbide matrix, wherein the ceramic coating layer coating the tri-structural isotropic nuclear fuel particles contracts more than the silicon carbide matrix, during a sintering procedure. The same document provides a composition that can prevent cracks and pores from occurring, during the sintering procedure, due to a difference in contraction between the ceramic coating layer of the tri-structural isotropic nuclear fuel particles and the silicon carbide matrix and that enables a compact fully ceramic microencapsulated nuclear fuel to be produced by performing a pressureless sintering procedure at a temperature of 1800° C. or less. In other words, by configuring a buffer layer having a significantly large shrinkage between the isotropic nuclear fuel and the silicon carbide matrix, cracks in the silicon carbide matrix may be prevented from occurring. However, in this case, since a buffer layer needs to be separately configured by an artificial method, this may result in procedural complexity.

When a fully ceramic microencapsulated nuclear fuel is used as a fuel for future-type nuclear reactors, small-sized urban nuclear reactors, nuclear reactors for nuclear-powered submarines and nuclear aircraft carriers, existing light water reactors, and high temperature gas-cooled reactors, generally, the volume fraction of multistructural isotropic nuclear fuel particles needs to be maximized. However, discussions are also being made on the need for controlling the volume fraction of multistructural isotropic nuclear fuel particles depending upon the applied field.

However, in fully ceramic microencapsulated nuclear fuels, a technology for maximizing volume fraction of multistructural isotropic nuclear fuel particles and a technology for controlling volume fraction of multistructural isotropic nuclear fuel particles have scarcely been reported.

### TECHNICAL OBJECTS

The present inventive concept is devised to resolve the above-described technical problems of the related art, and, therefore, a technical object of the present inventive concept is to provide a control method for volume fraction of multistructural isotropic fuel particles in fully ceramic microencapsulated nuclear fuels that can outstandingly enhance stability and tolerance against any nuclear fuel-related accidents.

Additionally, another technical object of the present inventive concept is to provide compositions for coating multistructural isotropic nuclear fuel particles that can enable a pressureless sintering procedure while maximizing volume fraction of multistructural isotropic nuclear fuel particles.

Additionally, another technical object of the present inventive concept is to provide a production method of a fully ceramic microencapsulated nuclear fuel by using a pressureless sintering procedure and a sintered body of the same, wherein the volume fraction of multistructural isotropic nuclear fuel particles is controlled.

Additionally, another technical object of the present inventive concept is to provide a control method for volume fraction of multistructural isotropic fuel particles in fully ceramic microencapsulated nuclear fuels that can implement procedural simplicity, by using multistructural isotropic nuclear fuel particles, which are configured of a nuclear fuel kernel, a porous carbon buffer layer, an inner pyrolytic carbon, a chemically vapor-deposited(CVD) SiC layer, an outer pyrolytic carbon layer, an organic coating layer, and so on, since buffering is not needed to be performed by artificially forming a matrix phase between a silicon carbide matrix and multistructural isotropic nuclear fuel particles, and since the silicon carbide matrix is used only to perform coating of the multistructural isotropic fuel particles, and since sintering needs to be performed without an applied pressure after carrying out a forming (or pressing) procedure.

Additionally, another technical object of the present inventive concept is to provide compositions for coating multistructural isotropic nuclear fuel particles, which are configured of Silicon Carbide, sintering additives, and organic binders, capable of preparing fully ceramic microencapsulated nuclear fuels through a pressureless sintering procedure, by using multistructural isotropic nuclear fuel particles, which are configured of a nuclear fuels kernel, a porous carbon buffer layer, an inner pyrolytic carbon, a chemically vapor-deposited (CVD) SiC layer, an outer pyrolytic carbon layer, an organic coating layer, and so on.

Additionally, another technical object of the present inventive concept is to prevent degradation in thermal conductivity of the fully ceramic microencapsulated nuclear fuel to a predetermined level by generating a more compact liquid between nuclear fuel particles and a silicon carbide matrix during a sintering process while partly mixing sintering aids having hardly any solubility in silicon carbide lattice, so that parts of the sintering aids included in the compact liquid, which is generated according to the formation of a eutectic liquid, can remain in the liquid without being employed to silicon carbide particles.

, another technical object of the present inventive concept is to provide a method preventing cracks from occurring between the silicon carbide matrix and the multistructural isotropic nuclear fuel particles that can allow a porous layer to buffer a difference in shrinkage between the silicon carbide matrix and the multistructural isotropic nuclear fuel particles, by forming an interfacial porous layer between the multistructural isotropic nuclear fuel particles and the coating layer, which is configured of silicon carbide, sintering additives, and organic binders, wherein an organic binder coating layer, which is formed on an outer most surface of each nuclear fuel particle, is thermally decomposed so as to be scattered into gaseous species, by using multistructural isotropic nuclear fuel particles, which are configured of a nuclear fuels kernel, a porous carbon buffer layer, an inner pyrolytic carbon, a chemically vapor-deposited (CVD) SiC layer, an outer pyrolytic carbon layer, an organic coating layer, and so on.

### Technical Solution

In order to achieve the above-described object of the present inventive concept, provided herein is a control method for volume fraction of multistructural isotropic fuel particles in fully ceramic microencapsulated nuclear fuels including a step of preparing a mixture of silicon carbide, sintering additives, and organic binders, a step of producing a coating body by coating multistructural isotropic fuel particles by using the prepared mixture, a step of forming the coating body, and a step of performing pressureless sintering on the formed coating body, wherein volume fraction of multistructural isotropic nuclear fuel particles may be controlled by controlling the coating layer thickness on multistructural isotropic nuclear fuel particles, wherein the coating layer was configured with a mixture of silicon carbide, sintering additives, and organic binders. Preferably, the sintering additives may be configured by including a selection from Aluminum Nitride (AlN), Yttria (Y₂O₃), Ceria (CeO₂), and Magnesia (MgO) or Strontia (SrO).

Preferably, the sintering additives may be configured by including a selection from Aluminum Nitride (AlN), Yttria (Y₂O₃), Scandia (Sc₂O₃), and Magnesia (MgO) or Strontia (SrO).

Preferably, a value of the sintering temperature may be within a range of 1750° C.˜ 1880° C.

Preferably, the volume fraction of multistructural isotropic nuclear fuel particles may be equal to a volume ratio relative to a total volume of the sintered body of 24% or more and 50% or less.

Preferably, when an added weight of silicon carbide and the sintering additives is given as 100 parts by weight, 91˜97 parts by weight of silicon carbide may be added, and 3˜9 parts by weight of the sintering additives may be added.

Preferably, 1.0˜3.5 parts by weight of the organic binders relative to a total volume of the coating body may be added.

Preferably, silicon carbide may have an average size ranging from 0.1 μm or more and less than 1.0 μm.

Preferably, in the coating step, a thickness of a coating layer of the multistructural isotropic fuel particles may be controlled to be within a range of 10˜375 μm by controlling a coating time.

Preferably, in the forming step, a pellet being first pre-formed by a uniaxial pressure forming procedure may be produced, and a green body may be produced subsequently by using a cold isostatic pressing procedure.

Preferably, when performing uniaxial pressure forming, a forming pressure may be within a range of 5˜20 MPa, and, when performing cold isostatic pressing, the forming pressure is within a range of 100˜300 MPa.

Preferably, the multistructural isotropic fuel particles may use multistructural isotropic fuel particles each having an organic binder coating layer formed on its outermost surface.

Preferably, in the sintering step, by having the organic binder coating layer be thermally decomposed and scattered into gaseous species and by forming an interfacial porous layer between the multistructural isotropic fuel particles and a matrix, the interfacial porous layer may buffer a difference in shrinkage between the silicon carbide matrix and the multistructural isotropic fuel particles, so as to prevent cracks from occurring between the silicon carbide matrix and the multistructural isotropic fuel particles.

Additionally, provided herein is a composition for coating multistructural isotropic fuel particles in a fully ceramic microencapsulated nuclear fuel including silicon carbide, and sintering additives, wherein the sintering additives are configured by including a selection from Aluminum Nitride (AlN), Yttria (Y₂O₃), Ceria (CeO₂), and Magnesia (MgO) or Strontia (SrO), or the sintering additives are configured by including a selection from Aluminum Nitride (AlN), Yttria (Y₂O₃), Scandia (Sc₂O₃), and Magnesia (MgO) or Strontia (SrO).

Preferably, when an added weight of silicon carbide and the sintering additives is given as 100 parts by weight, 91˜97 parts by weight of silicon carbide may be added, and 3˜9 parts by weight of the sintering additives may be added.

Additionally, provided herein is a silicon carbide sintered body including multistructural isotropic fuel particles in a fully ceramic microencapsulated nuclear fuel, wherein an organic binder coating layer being formed on an outermost surface of each multistructural isotropic fuel particle is thermally decomposed and scattered into gaseous species, and wherein an interfacial porous layer is formed between the multistructural isotropic fuel particles and a matrix in order to buffer a difference in shrinkage between the silicon carbide matrix and the multistructural isotropic fuel particles, so as to prevent cracks from occurring between the silicon carbide matrix and the multistructural isotropic fuel particles.

Preferably, the interfacial porous layer may have a thickness within a range of 1˜10 μm.

### Advantageous Effects

According to the above-described present inventive concept, an effect of outstandingly enhancing stability and tolerance against any nuclear fuel-related accidents is expected.

Additionally, in the present inventive concept, an effect of producing fully ceramic microencapsulated nuclear fuels while maximizing volume fraction of multistructural isotropic nuclear fuel particles is expected.

Additionally, in the present inventive concept, an effect of producing fully ceramic microencapsulated nuclear fuels having a controlled volume fraction of the multistructural isotropic fuel particles by performing a pressureless sintering procedure is expected. In other words, by controlling the thickness of a coating layer of each multistructural isotropic fuel particle during the procedure of coating the multistructural isotropic fuel particles, the volume fraction of the multistructural isotropic fuel particles may be controlled within a range of 24˜50% by volume.

Additionally, a matrix phase is not needed to be artificially formed between the silicon carbide matrix and the multistructural isotropic fuel particles in order to perform buffering, and the thickness of the coating layer on the multistructural isotropic fuel particles may be controlled by controlling the coating time, and since only the coating may be simply performed, and then the coating layer may be transformed into a SiC matrix after sintering, procedural simplicity may be implemented.

Additionally, by using multistructural isotropic nuclear fuel particles having an organic binder coating layer formed on an outermost surface of each multistructural isotropic nuclear fuel particle, the organic binder coating layer being formed on the outermost surface of each nuclear fuel particle is thermally decomposed, during the sintering procedure, so as to be scattered into a gas phase, and buffers the difference in shrinkage between the multistructural isotropic nuclear fuel particles and the silicon carbide matrix.

Additionally, during the sintering process, since the sintering additives reacts with an oxidized thin film (SiO₂) formed on a surface of silicon carbide particles, by forming a more dense liquid while using, among sintering aids, a sintering aid (Y₂O₃, MgO, SrO, CeO₂) that does not dissolve in silicon carbide and a sintering aid (Sc₂O₃) having almost no solubility, among the dense liquid formed in accordance with the formation of a eutectic liquid, by having part of the sintering aid remain in the liquid without being employed into the silicon carbide particles, degradation of thermal conductivity of the fully ceramic microencapsulated nuclear fuel may be minimized.

Additionally, by performing the pressureless sintering procedure, 24˜50% by volume of the multistructural isotropic nuclear fuel particles may be included in a fully ceramic microencapsulated nuclear fuel having a residual porosity of 3.5% or less.

### BRIEF DESCRIPTION OF THE DRAWINGS

FIG. 1 is a scanning electron microscopic image of multistructural isotropic nuclear fuel particles with an organic binder coating on the outermost surface, wherein the particles are non-coated multistructural isotropic nuclear fuel particles having a diameter of 868 μm.

FIG. 2 shows multistructural isotropic nuclear fuel particles having a coating layer thickness of 228 μm by coating the particles of FIG. 1.

FIG. 3 shows multistructural isotropic nuclear fuel particles having a coating layer thickness of 273 μm by coating the particles of FIG. 1.

FIG. 4 shows changes in volume fraction of multistructural isotropic nuclear fuel particles in a fully ceramic microencapsulated nuclear fuel pellet that is produced after changing the coating layer thickness of the multistructural isotropic nuclear fuel particles.

FIG. 5 shows a polished surface after cutting and polishing of a fully ceramic microencapsulated nuclear fuel, which is produced by using a pressureless sintering procedure.

FIG. 6 shows an interfacial condition of nuclear fuel particles and silicon carbide matrix that are observed through an electron microscope after sintering and producing fully ceramic encapsulated nuclear fuels.

### DETAILED DESCRIPTION

Hereinafter, the present inventive concept will be described in more detail based on the preferred embodiment and the appended drawings.

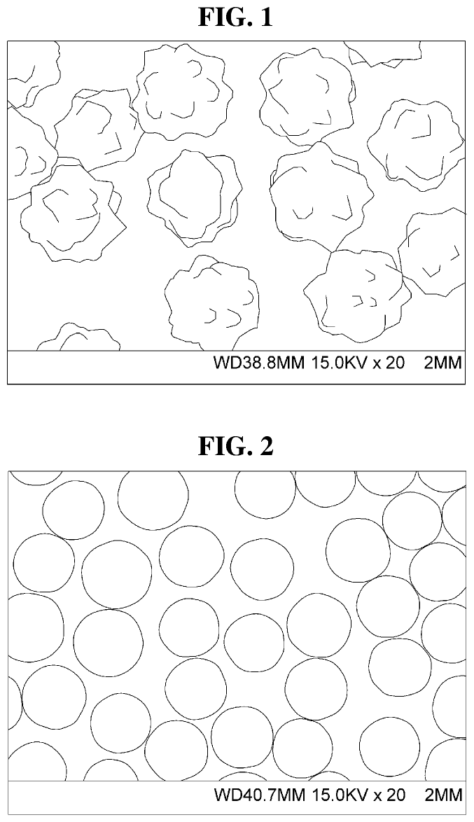

FIGS. 1-3 are scanning electron microscopic images of multistructural isotropic nuclear fuel particles each having a different coating layer thickness, by controlling a coating time by using a coating layer of a new composition.

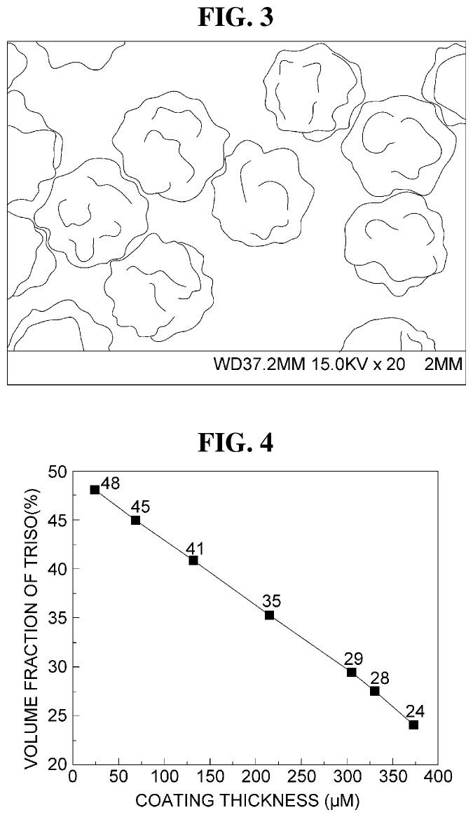

FIG. 1 shows non-coated multistructural isotropic nuclear fuel particles having a diameter of 868 μm, FIG. 2 shows multistructural isotropic nuclear fuel particles coated with a coating layer having a thickness of 228 μm, and FIG. 3 shows multistructural isotropic nuclear fuel particles coated with a coating layer having a thickness of 273 μm.

FIG. 4 shows changes in volume fraction of multistructural isotropic nuclear fuel particles in a fully ceramic microencapsulated nuclear fuel pellet that is produced after changing the coating layer thickness of the multistructural isotropic nuclear fuel particles.

As shown in the drawing, as the thickness of the coating layer of the multistructural isotropic nuclear fuel particles is reduced from 374 μm to 25 μm, it may be known that the volume fraction of the multistructural isotropic nuclear fuel particles in the fully ceramic microencapsulated nuclear fuel pellet increases from 24% to 48%.

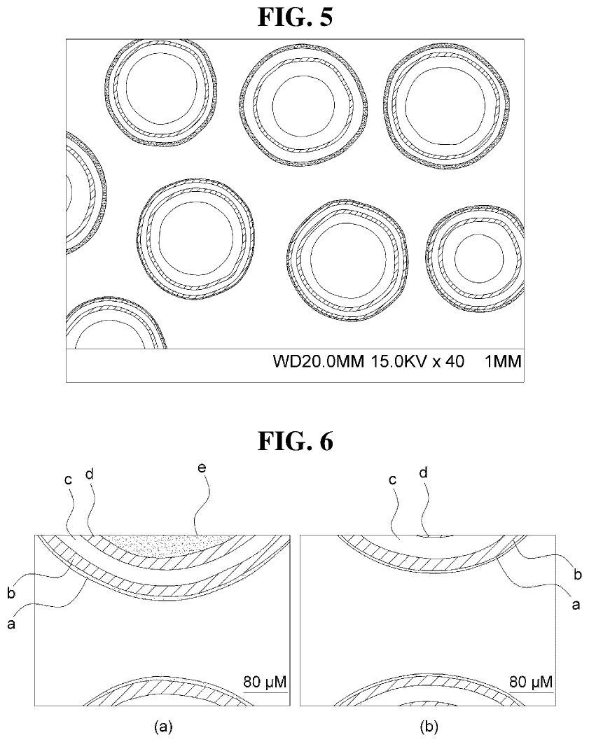

FIG. 5 shows a polished surface after cutting of a fully ceramic microencapsulated nuclear fuel, which is produced by using a pressureless sintering procedure. It may be verified that the multistructural isotropic nuclear fuel particles are evenly distributed on a crack-free Silicon carbide matrix.

FIG. 6 shows an interfacial condition of nuclear fuel particles and silicon carbide matrix that are observed through an electron microscope after sintering and producing fully ceramic encapsulated nuclear fuels. As shown in the drawing, it may be verified that an interfacial porous layer having a thickness of 1-5 μm is formed between an outer pyrolytic carbon layer and a silicon carbide matrix. Herein, a is an interfacial porous layer (where an organic binder coating layer existed before the sintering), b is an outer pyrolytic carbon layer, c is a SiC layer being formed by chemical vapor deposition, d is an inner pyrolytic carbon layer, and e is a porous carbon buffer layer. Preferably, the interfacial porous layer may be formed to have a thickness of up to 10 μm.

Preferably, when it is given that, among compositions, a whole ceramic (Silicon Carbide and sintering additive) is 100 part by weight, compositions for coating according to the present inventive concept include 91.0˜97.0 parts by weight of Silicon Carbide particles and 3.0˜9.0 parts by weight of sintering additives, wherein the sintering additives are materials being configured by selecting one of AlN, Y₂O₃, CeO₂, and MgO or SrO, or wherein the sintering additives are materials being configured by selecting one of AlN, Y₂O₃, Sc₂O₃, and MgO or SrO, and wherein organic binders for a forming procedure additionally include 1.0˜3.5 parts by weight.

Preferably, Silicon Carbide powder, which is used as a main material in the composition, is a submicron (generally refers to a size being less than 1 μm) powder having an average particle size equal to or greater than 0.1 μm and less than 1 μm. Preferably, the materials of AlN, Y₂O₃, CeO₂, MgO, Sc₂O₃, and SrO being used as the sintering additives have an average particle size of 5 μm or less.

A material being configured by selecting one of AlN, Y₂O₃, CeO₂, and MgO or SrO, or a composition of materials being configured by selecting one of AlN, Y₂O₃, Sc₂O₃, and MgO or SrO, being used as a sintering additive of the present inventive concept, reacts with silicon dioxide (or Silica (SiO₂)) on a surface of Silicon Carbide, which is the main material, at the sintering temperature, and configures a 5-component (or quinary) eutectic liquid or a multi-component eutectic liquid of more than 5 components due to the dissolution of Silicon Carbide. Thus, pressureless sintering may be performed by using a formed body without applying pressure even at a temperature range of 1750˜1880° C., which is a comparatively low temperature range as a Silicon Carbide sintering temperature. Therefore, the present inventive concept is advantageous in that fully ceramic microencapsulated nuclear fuels having outstandingly enhanced accident tolerance can be easily produced.

As described above, although fully ceramic microencapsulated nuclear fuels being configured of multiple multistructural isotropic nuclear fuel particles, which are mixed into a separately provided Silicon Carbide matrix, have been reported in prior arts (Korean Patent Registration No. 10-1793896 and No. 10-1677175), wherein the Korean Patent Registration No. 10-1793896 discloses a material that is produced by using a pressurized sintering method, which is a high-cost procedure, and wherein the Korean Patent Registration No. 10-1677175 discloses a more economical pressureless sintering procedure, a technology capable of controlling volume fraction of the multistructural isotropic nuclear fuel particles has not yet been reported, and the above-mentioned prior art inventions are disadvantageous in that a complicated 7-step procedure is used as the procedure for producing the fully ceramic microencapsulated nuclear fuel.

However, the fully ceramic microencapsulated nuclear fuel pellet including multistructural isotropic nuclear fuel particles according to the present inventive concept is advantageous in that (1) the volume fraction of the multistructural isotropic nuclear fuel particles can be controlled within a range of 24˜50% without applying a separate Silicon Carbide matrix, (2) by using a coating composition configured of a novel composition method having excellent sinterability by a novel combination of sintering aids, the residual porosity in a SiC matrix after sintering is very small, 3.5% or less, (3) since the sintering temperature is within a relatively low temperature range of 1750˜1880° C., excessive sintering or decomposition of uranium oxide or uranium nitride kernels within the multistructural isotropic nuclear fuel particles, may be prevented during the procedure, (4) a more simple production procedure configured of 4 steps may be used, and (5) since the production is made by using a pressureless sintering procedure that does not require a pressurizing device, the sintering equipment and procedure have become more simple.

A procedure for producing a fully ceramic microencapsulated nuclear fuel pellet having controlled volume fraction of multistructural isotropic nuclear fuel particles having a ceramic coating layer includes:

(1) a step of producing a mixture of compositions for coating including silicon carbide, sintering additives, and organic binders;

(2) a step of coating the multistructural isotropic nuclear fuel particles having controlled thicknesses by using the mixture of the compositions for coating;

(3) a step of producing a green body by using the mixture;

and

(4) a step of performing pressureless sintering on the green body.

Preferably, when it is given that, among compositions, a whole ceramic (Silicon Carbide and sintering additive) is 100 part by weight, compositions for coating according to the present inventive concept include 91.0˜97.0 parts by weight of Silicon Carbide particles and 3.0˜9.0 parts by weight of sintering additives, wherein the sintering additives are combination of materials being configured by selecting one of AlN, Y₂O₃, CeO₂, and MgO or SrO, or wherein the sintering additives are combination of materials being configured by selecting one of AlN, Y₂O₃, Sc₂O₃, and MgO or SrO, and wherein organic binders for a forming procedure additionally include 1.0˜3.5 parts by weight.

Additionally, both alpha-type phase and beta-type phase may be used for the Silicon carbide powder, and, preferably, submicron-sized (greater than 0.1 μm and less than 1 μm) powder may be used. Although silicon carbide particles having a particle size of less than 0.1 μm may be used, in the economical aspect, the usage of submicron powder is more appropriate.

In the present inventive concept, in case of the sintering additive being added for compaction of the coating layer, when using less than 3.0 parts by weight, it is disadvantageous in that the residual porosity exceeds 3.5% due to incomplete sintering, and, in case the content of sintering additives exceed 9.0 parts by weight, it is disadvantageous in that an excessive amount of liquid is formed, which results in an excessive loss of mass during the sintering process, and that the residual porosity exceeds 3.5%. Therefore, it is preferable that the total amount of sintering additives is limited to a range of 3.0˜9.0 parts by weight.

Organic binders that are added in order to facilitate the shape-forming procedure may be one or more organic binders being selected from polyethylene glycol, polymethyl methacrylate, paraffin, and polyvinyl butyral. However, the organic binders will not be limited only to the materials listed above. That is, any organic binder that aids (or helps) the coating of multistructural isotropic nuclear fuel particles may be used.

Preferably, the content of organic binders may include 1.0˜3.5 parts by weight. In case the content of organic binders is less than 1.0 parts by weight, it is not preferable due to the occurrence of defects in shape-forming. And, in case the content of organic binders exceeds 3.5 parts by weight, the organic binders decompose and disappear during the sintering process, which leads to the remaining of excessive pores that causes the disadvantageous for achieving residual porosity of 3.5% or less. Therefore, it is preferable to limit the content of organic binders within a range of 1.0˜3.5 parts by weight.

In the step of producing the composition for coating including silicon carbide, sintering additives, and organic binders, it is preferable to use an organic solvent for preventing significant oxidation of the silicon carbide particles as the solvent of the mixing procedure. The organic solvent will not be limited to a particular type, and, therefore, any organic solvent that can dissolve organic binders being additionally added apart from silicon carbide and the sintering additives may be used herein. More specifically, methanol, ethanol, propanol, butanol, hexane or acetone, and so on, may be used individually, or two or more types may be mixed and used.

The mixing procedure may be performed by conventional ball-milling procedure. At this point, it is preferable to use silicon carbide balls in order to prevent contamination from the balls, and, for the container, it is preferable to use a silicon carbide or plastic material container.

In the step of coating multistructural isotropic nuclear fuel particles having controlled thicknesses by using a mixture of compositions for coating, various methods such as a coating method using spray coating or a vibrating granulator or a rotary oscillating granulator or a rotary granulator, or a mixture of the coating methods listed above. However, the present inventive concept will not be limited only to the methods listed above, and, therefore, any coating method that can perform coating of multistructural isotropic nuclear fuel particles by using a composition configured of silicon carbide, sintering additives, and organic binders may be used herein.

The principle of the thickness of the coating layer of the multistructural isotropic nuclear fuel particles becoming thicker, in accordance with the coating time being extended during the procedure of coating the multistructural isotropic nuclear fuel particles, is used herein. And, therefore, it is preferable that the thickness of the coating layer on the multistructural isotropic nuclear fuel particles is within the range of 10˜375 μm. If the thickness of the coating layer is less than 10 μm, since the distance between the multistructural isotropic nuclear fuel particles within the fully ceramic microencapsulated nuclear fuel pellet becomes excessively short, there lies a problem in that cracks may occur within the SiC matrix. Additionally, in case the thickness of the coating layer exceeds 375 μm, the volume fraction of the multistructural isotropic nuclear fuel particles within the fully ceramic microencapsulated nuclear fuel pellet becomes less than 24%, which is excessively low, thereby causing a disadvantage of excessively decreasing a generating efficiency.

When producing the fully ceramic microencapsulated nuclear fuel pellet according to the present inventive concept, by controlling the thickness of the coating layer of the multistructural isotropic nuclear fuel particles, it will be advantageous in that the volume fraction of the multistructural isotropic nuclear fuel particles within the fully ceramic microencapsulated nuclear fuel pellet can be controlled within a range of 24% to 50%.

A uniaxial pressure forming procedure may be performed by injecting multistructural isotropic nuclear fuel particles coated with the compositions for the coating layer into a metallic mold, and, at this point, it is preferable to apply pressure within the range of 5˜20 MPa as the shape-forming pressure. And, afterwards, it is preferable to perform cold isostatic pressing at a pressure of 120˜300 MPa by inserting a green body in a rubber mold. If the pressure that is applied to shape-forming using a metallic mold is less than 5 MPa, there lies a problem of the preform strength (or green strength) becoming too weak for subsequent treatment. And, if a pressure exceeding 20 MPa is applied, since there lies a disadvantage in that the coating layer of the multistructural isotropic nuclear fuel particles is unevenly charged, it will be preferable to limit the applied pressure for performing uniaxial pressure forming by using a metallic mold to a range of 5˜20 MPa.

In case of applying a pressure of less than 120 MPa for the cold isostatic pressing pressure, since the packing of the green body is insufficient, there lies a disadvantage in that the content of remaining porosity after sintering exceeds 3.5%. And, it is not preferable to apply a pressure of 300 MPa or more, since cracks may occur in the multistructural isotropic nuclear fuel particles. In other words, it will be preferable to limit the pressure being applied when performing cold isostatic pressing to a range of 120˜300 MPa.

Preferably, the step of performing pressureless sintering on the green body may be performed by using a general graphite furnace at a temperature range of 1750˜1880° C. and under an argon atmosphere. And, it will be preferable that a retention time at a highest temperature is within a range of 0.5˜3 hours. During the sintering procedure, before reaching a highest temperature for thermal decomposition of the organic binders, it will be preferable to maintain the temperature within the range of 350˜600° C. during a time period of 0.5˜1 hour.

If the sintering temperature is less than 1750° C., since the sintering is not performed sufficiently, there lies a disadvantage in that the residual porosity after sintering exceeds 3.5%. And, if the sintering temperature exceeds 1880° C., there lies a disadvantage in that excessive grain growth may occur in uranium oxides (UO₂) or uranium nitride (UN) kernels within the multistructural isotropic nuclear fuel particles or, that decomposition of uranium nitride (UN) kernels into uranium (U) or nitrogen (N) may occur. Therefore, it will be preferable to limit the sintering temperature to a range of 1750˜1880° C.

During the sintering procedure, if the retention time at the highest temperature is less than 0.5 hour, there lies a disadvantage in that the sintering is not performed sufficiently. And, in case the retention time at the highest temperature exceeds 3 hours, since only grain growth occurs without any additional densification, it will not be preferable. Therefore, during the sintering procedure, it will be preferable to limit the retention time at the highest temperature to a range of 0.5˜3 hours.

Preferably, argon may be used for the sintering atmosphere. And, since a sintering atmosphere of oxygen or air causes oxidation of silicon carbide, such sintering atmosphere is not preferable for usage. And, since nitrogen degrades the sinterability of the SiC matrix, the usage of nitrogen for the sintering atmosphere is disadvantageous in that the remaining porosity exceeds 3.5% causing an excessive increase in porosity. Therefore, argon is most appropriate for the sintering atmosphere.

Meanwhile, a structure that can prevent cracks from occurring in the silicon carbide matrix will be described below.

An interfacial condition of the multistructural isotropic nuclear fuel particles and the silicon carbide matrix, which are observed through an electron microscope, after the sintering is shown in FIG. 6. Each of the multistructural isotropic nuclear fuel particles used in the present inventive concept has a center being configured of a uranium oxide or uranium nitride kernel and a porous carbon buffer layer formed on a surface of the kernel. Then, an inner pyrolytic carbon layer is formed on the porous carbon buffer layer, a silicon carbide deposition layer (CVD-SiC) is formed thereon, and an outer pyrolytic carbon layer is formed thereon, and an organic binder coating layer is formed on the outermost surface.

In the sintering step, the organic binder coating layer is thermally decomposed during the sintering process and escaped from the body to be sintered as gaseous species, and, as shown in FIG. 6, an interfacial porous layer remains between the multistructural isotropic nuclear fuel particles and the silicon carbide matrix.

Such interfacial porous layer performs a function of buffering a shrinkage difference between a silicon carbide matrix and the multistructural isotropic nuclear fuel particles. Thus, a dense fully ceramic microencapsulated nuclear fuel pellet may be obtained. In other words, high density and low residual porosity may be implemented, and accident tolerance in management may be ensured.

Hereinafter, the present inventive concept will be described in detail based on the embodiments of the present inventive concept. The proposed embodiments are merely exemplary, and, therefore, the scope of the present inventive concept will not be limited to the embodiments proposed herein.

### Embodiments 1-4, Comparison Examples 1-4

In this embodiment, as described below, a dense ceramic microencapsulated nuclear fuel pellet containing multistructural isotropic nuclear fuel particles embedded in a SiC matrix is produced by performing steps 1-1 to 1-4.

1-1. Production of a Powder Mixture of Compositions for a Ceramic Coating Layer Including Silicon Carbide, Sintering Additives, and Organic Binders

According to a ratio indicated as shown below in Table 1, a composition of a coating layer for coating multistructural isotropic nuclear fuel particles is prepared by mixing alpha-phase silicon carbide powder having an average particle diameter of 0.5 μm with aluminum nitride (AlN), yttria (Y₂O₃), magnesia (MgO), and ceria (CeO₂), each having an average particle diameter of 2 μm or less, as sintering additives, by performing a general ball-milling procedure. For 100 parts by weight of the composition, 1.5 parts by weight of polyvinyl butyral and 1.0 part by weight of polyethylene glycol are added as organic additives, and 75 parts by weight of ethanol is additionally added, and, then, ball-milling is performed for 24 hours by using a polypropylene container and silicon carbide balls, thereby obtaining a homogeneous slurry, and, then, the slurry is dried for 36 hours under a temperature of 60° C. by using a general dryer.

TABLE 1
Ceramic batch compositions for a coating layer

| | | Alpha Silicon | Aluminum | | | |
|---|---|---|---|---|---|---|
| Description | | Carbide | Nitride | Yttria | Magnesia | Ceria |
| (Part by Weight) | | (α-SiC) | (AlN) | (Y₂O₃) | (MgO) | (CeO₂) |
| Comparison | 1 | 96.50 | 2.12 | 0.86 | 0.52 | — |
| examples | 2 | 96.00 | 2.12 | 0.86 | 0.52 | 0.50 |
| | 3 | 96.00 | 2.12 | 0.86 | 0.52 | 0.50 |
| | 4 | 96.00 | 2.12 | 0.86 | 0.52 | 0.50 |
| Embodiments | 1 | 96.00 | 2.12 | 0.86 | 0.52 | 0.50 |
| | 2 | 95.60 | 2.32 | 1.06 | 0.52 | 0.50 |
| | 3 | 95.00 | 2.52 | 1.04 | 0.74 | 0.70 |
| | 4 | 94.00 | 2.62 | 2.36 | 0.52 | 0.50 |

Differences between comparison examples and embodiments will hereinafter be described.

1-2. Coating of multistructural isotropic nuclear fuel particles by using a mixture of compositions for a coating layer

Multistructural isotropic nuclear fuel particles having a controlled thickness and being coated with a silicon carbide composition are produced, as shown in FIG. 2, by coating multistructural isotropic nuclear fuel particles with the mixture of compositions for a coating layer, which is prepared by performing the above-described method of 1-1, for 30 minutes by using a rotary granulator and dried for 24 hours or more in a hot-air oven at a temperature of 70° C. At this point, the thickness of the coating layer is measured by observing the coated multistructural isotropic nuclear fuel particles by using a scanning electron microscope, as described in FIG. 2. Herein, the thickness is 228 μm.

1-3. Production of a Green Body by Using Coated Multistructural Isotropic Nuclear Fuel Particles

The multistructural isotropic nuclear fuel particles, which are coated by using the method of 1-2, are inserted in a metallic mold so as to produce a preform under a pressure of 10 MPa. Then, by performing cold isostatic pressing on the produced preform body under a pressure of 190 MPa, a cylindrical green body having a diameter of 13 mm and a height of 13 mm is produced.

1.4. Pressureless Sintering of the Green Body

Afterwards, the green body is processed with pressureless sintering under an argon atmosphere, which is a sintering condition indicated in Table 2, as shown below, thereby producing a fully ceramic microencapsulated nuclear fuel. In the sintering procedure, during a process of increasing the temperature up to the highest temperature, the temperature is maintained at 450° C. for 1 hour in order to perform thermal decomposition of the organic binders. Thereafter, the pressureless sintering procedure is carried out by applying heat so as to reach the highest temperature, as shown in Table 2.

Comparison example 1 prepares a mixture by using the same method as the above-described Embodiment 1, wherein ceria (CeO₂) is not added in the compositions for a ceramic coating layer, which is one of the core ideas of the present inventive concept, and wherein only aluminum nitride (AlN), yttria (Y₂O₃), and magnesia (MgO) are added as the sintering additives. And, Comparison example 1 performs coating of the multistructural isotropic nuclear fuel particles by using the same method as the above-described Embodiment 1 and performs pressureless sintering under the same conditions as the above-described Embodiment 1.

Comparison example 2 does not perform coating of the multistructural isotropic nuclear fuel particles, which is one of the core ideas of the present inventive concept, and uses a silicon carbide composition for a coating layer having the same composition as Embodiment 1, as shown in Table 1, so as to perform dry blending of the composition for the coating layer having the same amount of content as Embodiment 1 and the multistructural isotropic nuclear fuel particles having the same amount as Embodiment 1 for 6 hours by using a polypropylene container, and to produce a green body by using the dry-blended mixture by using the same method as Embodiment 1. Thereafter, Comparison example 2 prepares a fully ceramic microencapsulated nuclear fuel pellet by performing pressureless sintering under the same condition as the method of Embodiment 1.

Comparison example 3 performs pressureless sintering at a temperature of 1680° C., which deviates from the sintering temperature range of the present inventive concept, for 1 hour under an argon atmosphere by using the same green body as Embodiment 1.

Comparison example 4 performs pressureless sintering at a temperature of 1970° C., which deviates from the sintering temperature range of the present inventive concept, for 1 hour under an argon atmosphere by using the same green body as Embodiment 1.

TABLE 2
Pressureless sintering condition of the fully ceramic microencapsulated nuclear fuel pellet,
residual porosity, and volume fraction of multistructural isotropic nuclear fuel particles

| | | Pressureless Sintering | | | Volume fraction of |
|---|---|---|---|---|---|
| | | Condition | | | multistructural |
| | | Temp. | Time | Porosity | isotropic fuel |
| Description | | (° C.) | (h) | (%) | particles (%) |
| Comparison | 1 | 1850 | 1 | 10.6 | Cannot be measured due to |
| examples | | | | | multiple pores |
| | 2 | 1850 | 1 | Cannot be measured due to | Cannot be measured due to |
| | | | | severe cracks | severe cracks |
| | 3 | 1680 | 1 | 14.6 | Cannot be measured due to |
| | | | | | multiple pores |
| | 4 | 1970 | 1 | 5.5 | 32 |
| | | | | Microcracks | |
| Embodiments | 1 | 1850 | 1 | 1.7 | 35 |
| | 2 | 1860 | 1 | 1.9 | 34 |
| | 3 | 1830 | 2 | 2.4 | 34 |
| | 4 | 1850 | 1 | 2.0 | 34 |

As shown in Table 1 and Table 2, in case of Comparison example 1, wherein sintering was performed under the same condition as the above-described Embodiment 1 by not adding ceria (CeO₂) in the additive composition for the ceramic coating layer, which is a core idea of the present inventive concept, and adding only aluminum nitride (AlN), yttria (Y₂O₃), and magnesia (MgO) as the sintering additives, since the residual porosity of the fully ceramic microencapsulated nuclear fuel pellet was higher than 10%, the sintering procedure was not sufficiently performed, and, due to the presence of excessive residual pores in the sintered body of the fully ceramic microencapsulated nuclear fuel pellets, the volume fraction of the multistructural isotropic nuclear fuel particles could not be measured.

In case of Comparison example 2, coating of the multistructural isotropic nuclear fuel particles, which is one of the core ideas of the present inventive concept, is not performed, and a silicon carbide composition for a coating layer having the same composition as Embodiment 1, as shown in Table 1, and the composition for the coating layer having the same amount as Embodiment 1 and the multistructural isotropic nuclear fuel particles having the same amount as Embodiment 1 were dry blended together by using a polypropylene container, and a green body is produced by using the dry-blended mixture by using the same method as Embodiment 1, and pressureless sintering is performed under the same conditions as the method of Embodiment 1, severe cracks were observed throughout the entire fully ceramic microencapsulated nuclear fuel pellet. And, therefore, porosity and volume fraction of the multistructural isotropic nuclear fuel particles could not be accurately measured.

In case of Comparison example 3, pressureless sintering was performed at a low temperature of 1680° C., which deviates from the sintering temperature range of the present inventive concept, for 1 hour under an argon atmosphere by using the same green body as Embodiment 1. Due to the extremely high porosity of 14.6%, the fully ceramic microencapsulated nuclear fuel pellet was inappropriate for usage, and, due to the excessive remaining pores, volume fraction of the multistructural isotropic nuclear fuel particles could not be accurately measured.

In case of Comparison example 4, pressureless sintering was performed at a high temperature of 1970° C., which deviates from the sintering temperature range of the present inventive concept, for 1 hour under an argon atmosphere by using the same green body as Embodiment 1. Multiple microcracks have been observed in the sintered fully ceramic microencapsulated nuclear fuel pellet, and, due to its more or less high porosity of 5.5%, the fully ceramic microencapsulated nuclear fuel pellet was inappropriate for usage.

Therefore, in the Comparison examples 1˜4, since multiple cracks occur on the silicon carbide matrix, and, due to the excessively high porosity of 5% or more, the fully ceramic microencapsulated nuclear fuel pellets are not preferable for usage.

Conversely, the composition for the coating layer of the multistructural isotropic nuclear fuel particles according to Embodiments 1˜4 were prepared by adding 94.0˜96.0 parts by weight of Silicon carbide particles, 4.0˜6.0 parts by weight of AlN, Y₂O₃, MgO, and CeO₂ as sintering additives, and 2.5 parts by weight of organic binders, and the compositions were used to coat the multistructural isotropic nuclear fuel particles to a thickness of 228 μm, and ceramic microencapsulated nuclear fuel pellet green bodies were produced by performing uniaxial pressure forming and cold isostatic pressing methods by using the coated multistructural isotropic nuclear fuel particles, and the produced green bodies were processed with pressureless sintering at a temperature range of 1830˜1860° C. In the embodiments 1˜4 being produced as described above, no cracks occurred, the porosity is within a range of 1.7˜2.4%, and volume fraction of the multistructural isotropic nuclear fuel particles is within the range of 34˜35%.

### Embodiments 5-11

2-1 Preparation of a Powder Mixture of a Composition for a Ceramic Coating Layer Including Silicon Carbide, Sintering Additives, and Organic Binders

A composition for a coating multistructural isotropic nuclear fuel particles is prepared by adding 95.44 parts by weight of alpha-phase silicon carbide powder having an average particle diameter of 0.5 μm, and adding as sintering additives 2.05 parts by weight of aluminum nitride (AlN) having an average particle diameter of 1 μm or less, 1.33 parts by weight of yttria (Y₂O₃) having an average particle diameter of 1 μm or less, 0.68 parts by weight of ceria (CeO₂) having an average particle diameter of 2 μm or less, and 0.50 parts by weight of magnesia (MgO) having an average particle diameter of 1 μm or less, and adding as organic additives 1.50 parts by weight of polyvinyl butyral and 0.80 part by weight of polyethylene glycol, and adding 72 parts by weight of ethanol is additionally added, and, then, ball-milling is performed for 24 hours by using a polypropylene container and silicon carbide balls, thereby obtaining a homogeneous slurry, and, then, the slurry is dried for 36 hours under a temperature of 65° C. by using a general dryer.

2-2 Coating of Multistructural Isotropic Nuclear Fuel Particles by Using a Mixture of a Composition for a Coating Layer

Multistructural isotropic nuclear fuel particles were coated for 10˜245 minutes, as shown in Table 3, by using a mixture of a composition for a silicon carbide coating layer, which is produced by using the method of 2-1 and by using a rotary granulator, so as to control the thickness of the coating layer within a range of 25˜374 μm (at this point, the thickness of the coating layer of the multistructural isotropic nuclear fuel particles has increased from 25 μm to 374 μm in accordance with the extension of the coating time from 10 minutes to 245 minutes), and, then, by drying the coated multistructural isotropic nuclear fuel particles for 24 hours in a hot-air oven at a temperature of 70° C., multistructural isotropic nuclear fuel particles coated with a silicon carbide composition and having a controlled coating layer thickness are produced.

TABLE 3
Thickness of a coating layer of multistructural isotropic nuclear
fuel particles, porosity of a fully ceramic microencapsulated
nuclear fuel pellet produced by using the coated multistructural
isotropic nuclear fuel particles, and volume fraction of multistructural
isotropic nuclear fuel particles in a fully ceramic microencapsulated
nuclear fuel pellet

| | | Thickness of | | |
|---|---|---|---|---|
| | | multistructural | | Volume fraction |
| | | isotropic fuel | | of multistructural |
| | | particles coating | Porosity | isotropic fuel |
| Description | | layer (μm) | (%) | particles (%) |
| Embodiments | 5 | 25 | 2.8 | 48 |
| | 6 | 70 | 2.6 | 45 |
| | 7 | 133 | 2.4 | 41 |
| | 8 | 216 | 1.9 | 35 |
| | 9 | 306 | 1.8 | 29 |
| | 10 | 332 | 1.7 | 28 |
| | 11 | 374 | 1.4 | 24 |

2-3 Production of a Green Body by Using Coated Multistructural Isotropic Nuclear Fuel Particles

The multistructural isotropic nuclear fuel particles, which are coated by using the method of 2-2, are inserted in a metallic mold so as to produce a preform body by applying a pressure of 10 MPa. Then, by performing cold isostatic pressing on the produced preform body under a pressure of 204 MPa, a cylindrical green body having a diameter of 13.5 mm and a height of 13.5 mm is produced.

2.4 Pressureless Sintering of a Green Body

Afterwards, a fully ceramic microencapsulated nuclear fuel pellet of the present inventive concept is produced by performing pressureless sintering the green body at a temperature of 1850° C. for 2 hours under an argon atmosphere. In the sintering procedure, during a process of increasing the temperature up to the highest temperature, the temperature is maintained at 450° C. for 1 hour in order to perform thermal decomposition of the organic binders.

Table 3 shows that, as the thickness of the coating layer increases, the volume fraction of the multistructural isotropic nuclear fuel particles decreases in the fully ceramic microencapsulated nuclear fuel pellets.

The volume fraction of the multistructural isotropic nuclear fuel particles in the fully ceramic microencapsulated nuclear fuel pellets of the present inventive concept, which were produced by performing the above-described procedure, were within the range of 24˜48% to volume in the fully ceramic microencapsulated nuclear fuel pellets.

Such result is shown in FIG. 4, and it is shown in FIG. 4 that, as the thickness of the coating layer decreases from 374 μm to 25 μm, the volume fraction of the multistructural isotropic nuclear fuel particles increases from 24% to 48% in the fully ceramic microencapsulated nuclear fuel pellets.

As a polished surface after cutting of a fully ceramic microencapsulated nuclear fuel pellet, which is produced by using the method of the present inventive concept, FIG. 5 shows that the multistructural isotropic nuclear fuel particles are evenly distributed on a crack-free Silicon carbide matrix.

### Embodiment 12

3-1 Production of a Powder Mixture of a Composition for a Ceramic Coating Layer Including Silicon Carbide, Sintering Additives, and Organic Binders

A composition for a coating layer coating multistructural isotropic nuclear fuel particles is prepared by mixing 95.60 parts by weight of alpha-phase silicon carbide powder having an average particle size of 0.5 μm, with 2.15 parts by weight of aluminum nitride (AlN) having an average particle diameter of 1 μm or less, 1.28 parts by weight of yttria (Y₂O₃) having an average particle diameter of 1 μm or less, 0.52 parts by weight of scandia (Sc₂O₃) having an average particle diameter of 1 μm or less, and 0.45 parts by weight of strontia (SrO) having an average particle diameter of 1 μm or less, as the sintering additives. For 100 parts by weight of the composition, 1.80 parts by weight of polyvinyl butyral and 0.80 part by weight of polyethylene glycol are added as organic additives, and 75 parts by weight of ethanol is additionally added, and, then, ball-milling is performed for 24 hours by using a polypropylene container and silicon carbide balls, thereby obtaining a homogeneous slurry, and, then, the slurry is dried for 30 hours under a temperature of 65° C. by using a general dryer.

3-2 Coating of Multistructural Isotropic Nuclear Fuel Particles by Using a Mixture of Compositions for a Coating Layer

Multistructural isotropic nuclear fuel particles were coated by using a mixture of composition for a silicon carbide coating layer, which is produced by using the method of 3-1 and by using a rotary granulator, so that the thickness of the coating layer is 216 μm, and, then, by drying the coated multistructural isotropic nuclear fuel particles for 24 hours in a hot-air oven at a temperature of 70° C., multistructural isotropic nuclear fuel particles coated with a silicon carbide composition and having a coating layer thickness of 214 μm were produced.

3-3 Production of a Green Body by Using Coated Multistructural Isotropic Nuclear Fuel Particles

The multistructural isotropic nuclear fuel particles, which are coated by using the method of 3-2, were injected into a metallic mold so as to produce a preform body by applying a pressure of 13 MPa. Then, by performing cold isostatic pressing on the produced preform body under a pressure of 224 MPa, a cylindrical green body having a diameter of 13 mm and a height of 13 mm is produced.

3.4 Pressureless Sintering of a Green Body

Afterwards, a fully ceramic microencapsulated nuclear fuel pellet of the present inventive concept is produced by performing pressureless sintering the green body for 2 hours at a temperature of 1860° C. under an argon atmosphere. In the sintering procedure, during a process of increasing the temperature up to the highest temperature, the temperature is maintained at 450° C. for 1 hour in order to perform thermal decomposition of the organic binders.

The porosity of the prepared fully ceramic microencapsulated nuclear fuel pellet was 2.6%, and the volume fraction of the multistructural isotropic nuclear fuel particles was 36%.

### Embodiment 13

4-1. Production of a Powder Mixture of a Composition for a Ceramic Coating Layer Including Silicon Carbide, Sintering Additives, and Organic Binders

A composition for a coating layer coating multistructural isotropic nuclear fuel particles is prepared by mixing 94.10 parts by weight of alpha-phase silicon carbide powder having an average particle diameter of 0.5 μm, with 2.35 parts by weight of aluminum nitride (AlN) having an average particle diameter of 1 μm or less, 2.94 parts by weight of yttria (Y₂O₃) having an average particle diameter of 1 μm or less, 0.41 parts by weight of ceria (CeO₂) having an average particle diameter of 1 μm or less, and 0.20 parts by weight of strontia (SrO) having an average particle diameter of 1 μm or less, as the sintering additives. For 100 parts by weight of the composition, 1.50 parts by weight of polyvinyl butyral and 0.75 part by weight of polyethylene glycol are added as organic additives, and 75 parts by weight of ethanol is additionally added, and, then, ball-milling is performed for 24 hours by using a polypropylene container and silicon carbide balls, thereby obtaining a homogeneous slurry, and, then, the slurry is dried for 24 hours at a temperature of 70° C. by using a general dryer.

4-2. Coating of Multistructural Isotropic Nuclear Fuel Particles by Using a Mixture of a Composition for a Coating Layer

Multistructural isotropic nuclear fuel particles were coated by using a mixture of a composition for a silicon carbide coating layer, which is produced by using the method of 4-1 and by using a rotary granulator, so that the thickness of the coating layer is 210 μm, and, then, by drying the coated multistructural isotropic nuclear fuel particles for 24 hours in a hot-air oven at a temperature of 70° C., multistructural isotropic nuclear fuel particles coated with a silicon carbide composition and having a coating layer thickness of 210 μm are produced.

4-3. Production of a Green Body by Using Coated Multistructural Isotropic Nuclear Fuel Particles

The multistructural isotropic nuclear fuel particles, which were coated by using the method of 4-2, are inserted into a metallic mold so as to produce a preform body under a pressure of 20 MPa. Then, by performing cold isostatic pressing on the produced preform body under a pressure of 224 MPa, a cylindrical green body having a diameter of 13 mm and a height of 13 mm is produced.

4.4 Pressureless Sintering of a Green Body

Afterwards, a fully ceramic microencapsulated nuclear fuel pellet of the present inventive concept is produced by performing pressureless sintering the green body at a temperature of 1880° C. for 2 hours under an argon atmosphere. In the sintering procedure, during a process of increasing the temperature up to the highest temperature, the temperature is maintained at 450° C. for 1 hour in order to perform thermal decomposition of the organic binders.

The porosity of the prepared fully ceramic microencapsulated nuclear fuel pellet is 3.3%, and the volume fraction of the multistructural isotropic nuclear fuel particles was 37%.

### Embodiment 14

When producing a powder mixture of a composition for a ceramic coating layer including silicon carbide, sintering additives, and organic binders only the composition for the coating layer is varied, as described below, and all of the other procedures have been carried out under the same conditions as Embodiment 13, so as to produce the fully ceramic microencapsulated nuclear fuel pellet of Embodiment 14.

The composition for a ceramic coating layer is used in a subsequent procedure by preparing a composition for a coating layer coating multistructural isotropic nuclear fuel particles by mixing 93.50 parts by weight of alpha-phase silicon carbide powder having an average particle diameter of 0.5 μm, with 2.25 parts by weight of aluminum nitride (AlN) having an average particle diameter of 1 μm or less, 3.45 parts by weight of yttria (Y₂O₃) having an average particle diameter of 1 μm or less, 0.45 parts by weight of magnesia (MgO) having an average particle diameter of 1 μm or less, and 0.35 parts by weight of scandia (Sc₂O₃) having an average particle diameter of 1 μm or less, as the sintering additives.

The porosity of the prepared fully ceramic microencapsulated nuclear fuel pellet is 3.1%, and the volume fraction of the multistructural isotropic nuclear fuel particles was 36%.

Although the preferred embodiment of the present inventive concept is described herein, this is merely exemplary, and, therefore, the interpretation of the scope and spirit of the present inventive concept will not be limited to the exemplary embodiment presented herein. Thus, it will be apparent that the present inventive concept shall be interpreted according to the technical scope and spirit of the present inventive concept set forth herein.

1. A control method for volume fraction of multistructural isotropic fuel particles in a fully ceramic microencapsulated nuclear fuel pellet, comprising:
a step of preparing a mixture of silicon carbide, sintering additives, and organic binders;
a step of producing a coating body by coating multistructural isotropic fuel particles by using the prepared mixture;
a step of forming the coating body; and
a step of performing pressureless sintering on the formed body;
wherein volume fraction of multistructural isotropic nuclear fuel particles is controlled by controlling the thickness of coating layer on the multistructural isotropic fuel particles.

2. The control method of claim 1, wherein the sintering additives are configured by including a selection from Aluminum Nitride (AlN), Yttria (Y₂O₃), Ceria (CeO₂), and Magnesia (MgO) or Strontia (SrO).

3. The control method of claim 1, wherein the sintering additives are configured by including a selection from Aluminum Nitride (AlN), Yttria (Y₂O₃), Scandia (Sc₂O₃), and Magnesia (MgO) or Strontia (SrO).

4. The control method of claim 1, wherein a value of the sintering temperature is within a range of 1750° C.˜1880° C.

5. The control method of claim 1, wherein the volume fraction of multistructural isotropic nuclear fuel particles is equal to a volume ratio relative to a total volume of the sintered body of 24% or more and 50% or less.

6. The control method of claim 1, wherein, when an added weight of silicon carbide and the sintering additives is given as 100 parts by weight, 91˜97 parts by weight of silicon carbide are added, and 3˜9 parts by weight of the sintering additives are added.

7. The control method of claim 1, wherein 1.0˜3.5 parts by weight of the organic binders relative to a total volume of the coating body is added.

8. The control method of claim 1, wherein silicon carbide has an average size ranging from 0.1 μm or more and less than 1.0 μm.

9. The control method of claim 1, wherein, in the coating step, a thickness of a coating layer of the multistructural isotropic fuel particles is controlled to be within a range of 10˜375 μm by controlling a coating time.

10. The control method of claim 1, wherein, in the forming step, a pellet being first pre-formed by a uniaxial pressure forming procedure is produced, and a green body is produced subsequently by using a cold isostatic pressing procedure.

11. The control method of claim 10, wherein, when performing uniaxial pressure forming, a forming pressure is within a range of 5˜20 MPa, and, when performing cold isostatic pressing, the forming pressure is within a range of 100˜300 MPa.

12. The control method of claim 1, wherein the multistructural isotropic fuel particles having an organic binder coating layer formed on their outermost surface are used.

13. The control method of claim 12, wherein, in the sintering step, by having the organic binder coating layer be thermally decomposed and scattered into gaseous species and by forming an interfacial porous layer between the multistructural isotropic fuel particles and a matrix, the interfacial porous layer buffers a difference in shrinkage between the silicon carbide matrix and the multistructural isotropic fuel particles, so as to prevent cracks from occurring between the silicon carbide matrix and the multistructural isotropic fuel particles.

14. A composition for coating multistructural isotropic fuel particles in a fully ceramic microencapsulated nuclear fuel, the composition comprising:
silicon carbide; and
sintering additives,
wherein the sintering additives are configured by including a selection from Aluminum Nitride (AlN), Yttria (Y₂O₃), Ceria (CeO₂), and Magnesia (MgO) or Strontia (SrO), or the sintering additives are configured by including a selection from Aluminum Nitride (AlN), Yttria (Y₂O₃), Scandia (Sc₂O₃), and Magnesia (MgO) or Strontia (SrO).

15. The composition of claim 14, wherein, when an added weight of silicon carbide and the sintering additives is given as 100 parts by weight, 91˜97 parts by weight of silicon carbide are added, and 3˜9 parts by weight of the sintering additives are added.

16. A silicon carbide sintered body including multistructural isotropic fuel particles in a fully ceramic microencapsulated nuclear fuel, wherein an organic binder coating layer being formed on an outermost surface of each multistructural isotropic fuel particle is thermally decomposed and scattered into gaseous species, and wherein an interfacial porous layer is formed between the multistructural isotropic fuel particles and a matrix in order to buffer a difference in shrinkage between the silicon carbide matrix and the multistructural isotropic fuel particles, so as to prevent cracks from occurring between the silicon carbide matrix and the multistructural isotropic fuel particles.

17. The silicon carbide sintered body of claim 16, wherein the interfacial porous layer has a thickness within a range of 1˜10 μm.
